(19) United States
(12) Patent Application Publication
(10) Pub. No.: US 2002/0089706 A1
(43) Pub. Date: Jul. 11, 2002

(54) Image reading device capable of reading images continuously

(76) Inventor: Youngs Wong, Tainan (TW)

Correspondence Address: RABIN & BERDO, P.C., Suite 500, 1101 14th Street, N.W., Washington, DC, 20005, US

(21) Appl. No.: 10/032,556

(22) Filed: Jan. 2, 2002

(30) Foreign Application Priority Data
Jan. 5, 2001 (TW) 90100316

(51) Int. Cl. H04N 1/46

(52) U.S. Cl. 358/505; 358/514

(57) ABSTRACT

An image reading device capable of continuously reading images comprises a continuous reading controller switch and a control unit. The continuous reading controller switch receives continuous instructions and outputting a control signal to control the continuous reading and outputting operations of the image reading device. The control unit is used for controlling the image reading device and receiving the control signal to implement the continuous reading and outputting operations of the image reading device. While there are a lot of documents to be copied or scanned, the image reading device can reduce some repeating operations and increase the convenience.

This application incorporates by reference Taiwanese application Serial No. 90100316, Filed Jan., 5, 2001.

### BACKGROUND OF THE INVENTION

1. Field of the Invention

This invention relates to an image reading device, particularly to an image reading device capable of reading images continuously.

2. Description of the Related Art

Benefited from the printing technology, the scanner, and the copier, the information has been distributed more and more easily and conveniently. When there are a lot of documents to be scanned or copied, the documents can be placed on an automatic document feeder capable of feeding documents automatically to the scanner or the copier, instead of being placed one by one manually.

However, the scanner with an automatic document feeder is very expensive. It is very cost for the user who doesn't always have a large amount of documents to be copied or scanned. Moreover, it is extremely difficult to photocopy or scan one book by the automatic document feeder if the book is not separated into many papers. In order to maintain the integrity of the book, it is usually processed manually. The user turns over the page that is copied or scanned, then presses the key of “STRAT” to let the copier or the scanner read the next page. And the steps are repeated again and again. The repeating operations of turning over the page and pressing the “START” key really disturb the user and cost much time.

For example, the users should repeat the operation of turning over the page scanned and give the instruction by a keyboard or a mouse for 2000 times while a dictionary with 2000 pages is needed to be scanned. This is really inconvenient for the users.

For the above, a solution is desirous to solve this problem.

### SUMMARY OF THE INVENTION

The object of the present invention is to provide an image reading device capable of reading images continuously. When the user wants to scan a book, the image reading device will start reading and outputting the image information as soon as the user turns over the page scanned and places the next page on the scanner. Using the present invention, the user can process the image reading operations continuously without pressing the “START” button again and again, which reduces the repeated operations and increases the convenience.

The image reading device capable of reading images continuously according to the present invention includes a continuous reading controller switch and a control unit. The continuous reading controller switch receives instructions continuously and outputs a control signal to control the continuous reading and outputting operations of the image reading device. The control unit is used for controlling the continuous image reading device and receiving the control signal to implement the continuous reading and outputting operations of the image reading device. While there are a lot of documents to be copied or scanned, the image reading device can reduce some repeating operations and increase the convenience.

The image reading device further comprises a time adjuster to adjust the time period between two adjacent operations of image reading.

### BRIEF DESCRIPTION OF THE DRAWINGS

The above objects and other advantages of the present invention will become more apparently by describing in detail the preferred embodiment of the present invention with reference to the attached drawings in which:

FIG. 1 is a schematic illustration showing an image reading device capable of reading images continuously in accordance with a preferred embodiment of the invention; and

FIG. 2 is a block diagram showing the connection between the scanner in FIG. 1 and a continuous reading controller in accordance with another embodiment of the invention.

### DESCRIPTION OF THE PREFERRED EMBODIMENTS

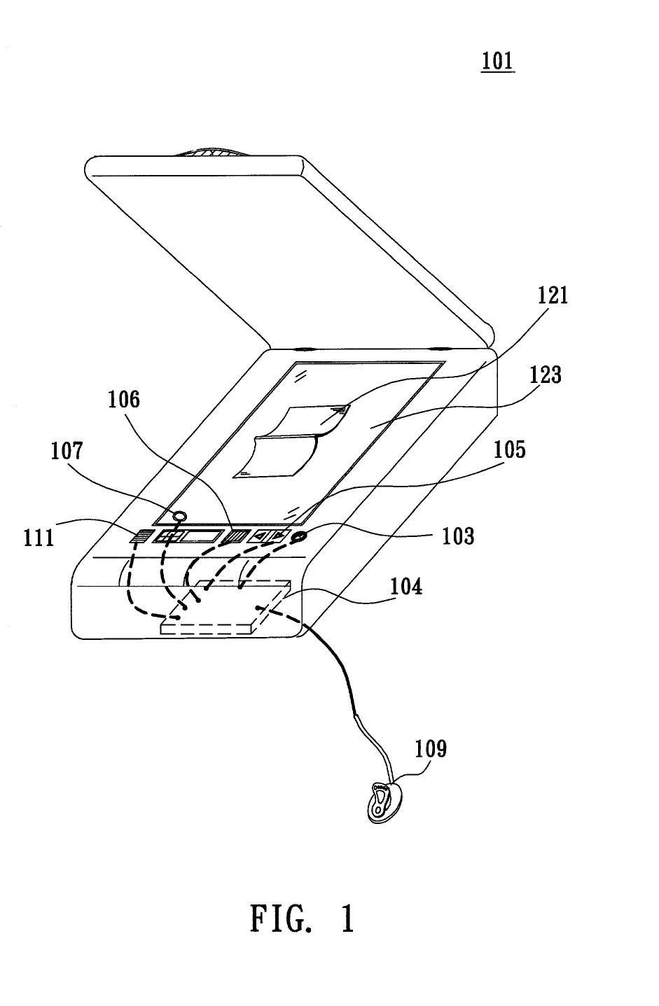

In the preferred embodiments, the image reading device of the present invention takes the scanner as an example. However, it will not limit the scope of the present invention. Referring to FIG. 1, the scanner 101 has the function of continuously reading the document and outputting some image information. The document to be processed includes several papers and can't be processed by the automatic document feeder. Particularly, the papers are bound as a volume, for instance as a book 121.

As shown in FIG. 1, scanner 101 includes a continuous reading controller switch 103 and a control unit 104. By receiving the continuous reading instruction from the user, the continuous reading controller switch 103 outputs a control massage to initiate the scanner 101 into the continuous reading condition. The operations of the continuous reading and outputting are controlled by the control massage. The continuous reading controller switch 103 can be a touch-type or non-touch-type button. For example, the user can output the continuous reading instruction by pressing the continuous reading controller switch 103. For the control unit 104, it receives the control massage from the continuous reading controller switch 103 to drive the scanner 101 to read the documents and output the image information continuously.

The operations of continuous reading and outputting means the documents to be processed will be scanned by the scanner 101 without the traditional action of pressing the “START” button, as only as the document to be scanned is prepared ready on the scanner 101. While the user wants to scan the content of the book 121, the book 121 is put on the plane 123 of the scanner 101. Then, the user initiates the continuous reading controller switch 103 and the scanner 101 is in the continuous reading condition. As the page is finished the scanning and turned over by the user, the scanner 101 reads the image of the next page and outputs the image information. Therefore, the step of the pressing “START” button for the traditional method can be skipped after the scanned page is turned over.

The time period between two adjacent document reading operations is predetermined in the scanner 101. It is long enough for the user to finish the operation of turning over the scanned page. The scanner 101 further comprises a time adjuster 105. Depending on the practical operation, the user can adjust the time duration between two adjacent reading steps with the time adjuster 105. The time adjuster 105 has a speedup button and a slowdown button, or an adjusting rotator to facilitate the function of the increasing or decreasing the time period.

Moreover, the scanner 101 may further comprise a detector 107 to detect whether the user has turned over the scanned page and is in the waiting condition. If the scanned page is turned over and the user has no action during the predetermined period—about 2 to 5 seconds for example, the detector 107 will outputs a reading signal to the control unit 104 to initiate the scanner 101.

The scanner 101 may also comprises an audio-receiver 111. After the user turns over the scanned page and delivers an audio-signal, the audio-receiver 111 receives the audio-signal and outputs a reading signal to the control unit 104. Afterwards, the scanner 101 starts to process the reading. In addition, the scanner 101 may comprises a stepping-controller 109. To start the continuous scan, the user outputs the reading signal to the control unit 104 by stepping the stepping-controller 109.

Furthermore, the scanner 101 may comprises an indicator 106 for informing the user to turn over the scanned page, as the scanning completed. And the indicator 106 can be an audio-indicator, a light-indicator or an audio-light-indicator to remind the user by the audio or light, respectively.

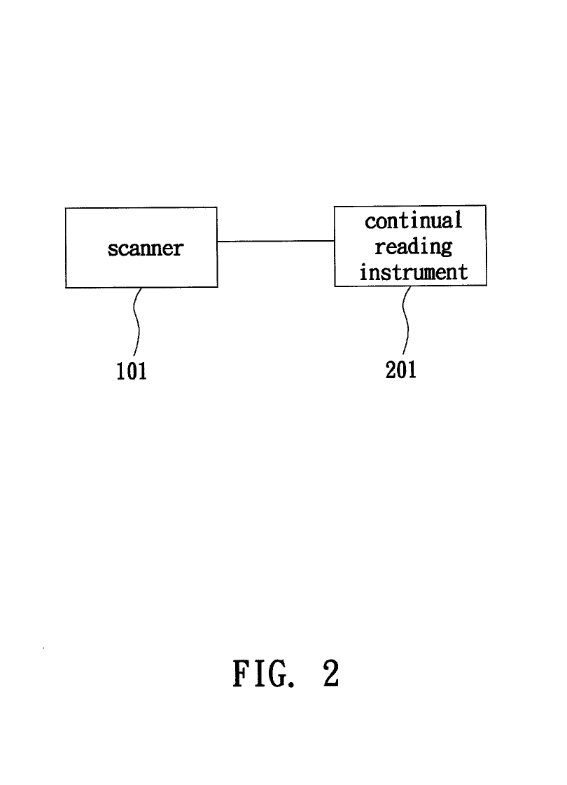

As shown in FIG. 1, the continuous reading controller switch 103, time adjuster 105, indicator 106, detector 107, stepping controller 109 and the audio-receiver 111 are installed on the scanner 101. However, they will not limit the scope of the present invention. Please referring FIG. 2, another embodiment of the present invention is that the continuous reading device 201 is installed out of the scanner 101. The continuous reading device 201 can be a continuous reading controller switch, a time adjuster, an indicator, a detector, a stepping controller or an audio receiver.

The embodiment of the present invention described above takes the scanner 101 as an example. However, it should not limit the scope of the present invention. Any image reading device utilizing the features of the present invention is within the scope of the present invention. The image reading device can be a copier or a facsimile machine.

The present invention discloses a continuous image reading device and has the advantages as followings. When the user wants to scan a book, the image reading device will start reading and outputting the image information as soon as the user turns over the page scanned. Using the present invention, the user can process the image reading operation continually without pressing the “START” button again and again, which reduces the repeating operations and increases the convenience. For example, the user only needs to set up in the beginning and then repeats turning over the pages when the user wants to scan the dictionary with 2000 pages. This really helps a lot to scan a lot of documents. Moreover, the user doesn't need to purchase the expensive automatic document feeder device and can make the scan of small quantity more convenient by the scanner in the present invention or by installing the continuous image reading device provided in the present invention when the user wants to scan a document having 50 pages.

Once given the above disclosure, many other features, modifications, and improvement will become apparent to the skilled artisan. Such other features, modifications, and improvements are, therefore, considered to be a part of this invention, the scope of which is to be determined by the following claims.

What is claimed is:

1. An image reading device for reading documents to be processed continuously and outputting a plurality of image information, said image reading device comprising:
a continuous reading controller switch for receiving continuous instructions and outputting a control signal to control the continuous reading and outputting operations of said image reading device; and
a control unit for controlling said image reading device and receiving said control signal to implement the continuous reading and outputting operations of said image reading device.

2. The image reading device of claim 1 further comprising a time adjuster to adjust the time period between two adjacent operations of image reading.

3. The image reading device of claim 2, wherein said time adjuster further comprises a speedup button and a slowdown button to decrease and increase the time period respectively.

4. The image reading device of claim 2, wherein said time adjuster further comprises a rotator to adjust the time period.

5. The image reading device of claim 1 further comprising a detector for outputting a reading signal to said control unit to initiate the reading operation of said image reading device when no action within a predetermined period after the scanned page is turned over is detected.

6. The image reading device of claim 5 further comprising a plane for loading the document to be processed, said detector being positioned under said plane.

7. The image reading device of claim 1 further comprising an audio-receiver for receiving the audio signal and outputting a reading signal to said control unit to control the reading operation of said image reading device.

8. The image reading device of claim 1 further comprising a stepping-controller, wherein the user steps said stepping-controller to output a reading signal to said control unit for controlling the reading operation of said image reading device.

9. The image reading device of claim 1 further comprising an indicator for informing the user to turning over the page.

10. The image reading device of claim 9, wherein said indicator is selected from the group consisting of an audio-indicator, a light-indicator and an audio-light-indicator.

11. A continuous reading controller switch coupled with a image reading device to control the continuous reading and outputting operations of said image reading device, said controller comprising:
a continuous reading controller switch for receiving instructions continuously and outputting a control signal to control the continuous reading and outputting operations of said image reading device.

12. The image reading device of claim 11 further comprising a time adjuster to adjust the time period between two adjacent operations of image reading.

13. The image reading device of claim 12, wherein said time adjuster further comprises a speedup button and a slowdown button to decrease and increase the time period respectively.

14. The image reading device of claim 12, wherein said time adjuster further comprises a rotator to adjust the time period.

15. The image reading device of claim 11 further comprising a detector for outputting a reading signal to said control unit to initiate the reading operation of said image reading device when no action within a predetermined period after the scanned page is turned over is detected.

16. The image reading device of claim 15 further comprising a plane for loading the document to be processed, said detector being positioned under said plane.

17. The image reading device of claim 11 further comprising an audio-receiver for receiving the audio signal and outputting a reading signal to said control unit to control the reading operation of said image reading device.

18. The image reading device of claim 11 further comprising a stepping-controller, wherein the user steps said stepping-controller to output a reading signal to said control unit for controlling the reading operation of said image reading device.

19. The image reading device of claim 11 further comprising an indicator for informing the user to turning over the page.

20. The image reading device of claim 19, wherein said indicator is selected from the group consisting of an audio-indicator, a light-indicator and an audio-light-indicator.
